(19) United States
(12) Patent Application Publication
(10) Pub. No.: US 2017/0185646 A1
(43) Pub. Date: Jun. 29, 2017

(54) SYSTEM AND METHOD FOR PROVIDING A FRAMEWORK HAVING A QUERY BUILDING LOGIC

(71) Applicant: Cognizant Technology Solutions India Pvt. Ltd., Chennai (IN)

(72) Inventors: Gopinath Mandala, Chennai (IN); Shalini Anandan, Chennai (IN); Arun Kumar Shanmugam, Chennai (IN)

(21) Appl. No.: 15/094,614

(22) Filed: Apr. 8, 2016

(30) Foreign Application Priority Data
Dec. 29, 2015 (IN) 7033/CHE/2015

(51) Int. Cl. G06F 17/30; G06F 11/36

(52) U.S. Cl. CPC G06F 17/30466; G06F 17/30598; G06F 17/30477; G06F 17/30914; G06F 11/3668

(57) ABSTRACT

A system and a method for providing a query building logic for supporting testing requirements are disclosed. The system receives one or more business inputs from one or more users. An application database is configured for rendering one or more unique database schemas and a set of predefined parameters. The application database is accessed by at least one user to select one or more database schemas and identify a set of predefined parameters, based on one or more business conditions set for the at least one user. Further, the system comprises a TDS (Test Data Specification) framework that is configured to dynamically frame one or more queries based on one or more business inputs, selected database schemas and the identified predefined parameters by the one or more users.

### FIELD OF THE INVENTION

The present invention relates generally to the field of database queries and more particularly to configuration of a framework having an in-built query framing logic.

### BACKGROUND OF THE INVENTION

Database queries are built to extract information or data from a database. The database queries may be formed based on the structure of the database, also termed as database schema. A database schema defines structures of the database, such as one or more tables or columns, one or more fields of each of the tables, relationships between the fields, tables etcetera. A sound acquaintance with the database schema helps the users to construct effective and useful queries for accessing data from a database.

In the field of software testing, quality assurance testers or QA Testers extract data from one or more databases for executing various test cases. The QA Testers would rely on Development team/DBA who use structured query language (SQL) to form queries in order to access the data in a database by writing one or more expression to specify the relationship of two or more tables, columns, fields and attributes of the database. The queries are generally formed based on one or more prerequisite conditions for which the QA Testers want the test data that are needed for executing their test cases. The one or more prerequisite conditions may include the ‘business conditions’ based on which, the users or testers want to check the availability of the data and also to validate the fitment of data searched.

However, the data that lies in the database can only be searched by probing through the one or more tables/columns of the database, which requires technical skills of the users. To retrieve the required test data, the user is required to have a sound knowledge about the complete data model of the database that may include one or more physical constraints as well as logical constraints. The physical constraints are maintained in database layer, whereas logical constraints are maintained in application layer. The user or the tester is required to be familiar with the technicalities of both the database layer and the application layer, in order to extract the required data with precision. An incorrect set of searched data may result in errors in testing. Thus, there exists a challenge for the users/QA testers to extract the desired test data based on the business conditions so as to efficiently execute the test scenarios.

Various tools such as query builders, exist in the art that facilitate a user to build database queries in order to search the required data for testing. However, these query builders address only the physical constraints of the database. In other words, these tools build query by using only the tables that have physical relationship or physical constraints, and will accept input as the exact table name and column name in the database layer. These tools do not generate queries based on logical constraints of the database. As a result, these query builders creates a dependency on knowing the complete information of the data model by the testers.

In light of the above, there is a need for a system and method to provide a framework having a query building logic for supporting testing requirements based on prerequisite business conditions of the testers. Further, there is a need for a system and method to provide for a framework that aid the users to precisely extract data for testing by generating effective queries. Furthermore, there is a need for a system and method to analyze complex business conditions and to extract data required for testing based on the analyzed business conditions. In addition, there is a need for a system and method to dynamically build one or more queries corresponding to the prerequisite business conditions without having the need to know complex query language programming SQL.

### SUMMARY OF THE INVENTION

A system and a computer-implemented method for providing a query building logic for supporting testing requirements are provided.

In one embodiment of the present invention the system for providing the query building logic comprises one or more computer processors executing program instructions stored in one or more storage devices. At least one computer processor of the one or more computer processors configures a business input module, an application database, and a TDS (Test Data Specification) framework. The business input module receives one or more business inputs from one or more users. The application database for rendering one or more unique database schemas and a set of predefined parameters. The application database is accessed by at least one user to select one or more database schemas and identify one or more predefined parameters based on one or more business conditions set for the at least one user. The TDS (Test Data Specification) framework comprises a dynamic query framing module for dynamically generating one or more queries based on the one or more business inputs, the selected one or more database schemas, and the identified one or more parameters.

The TDS framework establishes a connection with the application database using one or more communication channels to extract the selected one or more database schemas. The TDS framework communicates with the business input module to receive the one or more business inputs.

A staging environment module is provided for maintaining metadata of the application database, and maintaining mapping information pertaining to the one or more database schemas of the application database. Further, a business condition parser is provided for parsing the business inputs received from the users and classifying the parsed data into one or more entities, one or more parameters, and the one or more business conditions.

A keyword translator is provided for analyzing the one or more entities and one or more parameters based on the one or more business conditions. The keyword translator also selects the one or more analyzed entities and parameters based on user preferences; and map the one or more selected entities and parameters based on the mapping information.

A query building logic is provided that comprises a select clause framing module, an inner join clause framing module and a where clause framing module, wherein each module separately frames one or more clauses of the query generated. The query is generated by the dynamic query framing module by combining the separately formed one or more clauses.

In one embodiment of the present invention, the method for providing a query building logic for supporting testing requirements, the method comprises the steps of: configuring one or more computer processors by executing program instructions stored in one or more storage devices. At least one computer processor of the one or more computer processors being configured for: receiving one or more business inputs from one or more users via one or more user communication devices; rendering one or more unique database schemas and a set of predefined parameters by an application database, wherein the application database is being accessed by at least one user to select one or more database schemas and identify one or more predefined parameters based on one or more business conditions set for the at least one user; configuring a TDS (Test Data Specification) framework comprising a dynamic query framing module for dynamically generating one or more queries based on the one or more business inputs and the selected one or more database schemas; wherein the TDS framework establishes a connection with the application database using one or more communication channels to extract the selected one or more database schemas, further wherein the TDS framework communicates with the business input module to receive the one or more business inputs.

In various embodiments of the present invention, the one or more entities are mapped to one or more tables by using the mapping information. The one or more parameters are mapped to one or more columns by using the mapping information. The one or more business conditions are mapped to Referential Integrity (RI) by using the mapping information.

### BRIEF DESCRIPTION OF THE ACCOMPANYING DRAWINGS

The present invention is described by way of embodiments illustrated in the accompanying drawings wherein:

FIG. 1 is a block diagram illustrating a system for providing a test data specification (TDS) framework, in accordance with an embodiment of the present invention;

FIG. 2 illustrates parsing of the user inputs and keywords for identifying the entities, parameters and business conditions, in accordance with an embodiment of the present invention;

FIG. 3 is the representation of entity and parameter mapping, in accordance with an embodiment of the present invention;

FIG. 4 illustrates representations of three-tier mapping of one or more entities, parameters, and business conditions for a business domain, in accordance with an exemplary embodiment of the present invention;

FIG. 5 is a flowchart illustrating the process of configuring the TDS framework, in accordance with an embodiment of the present invention;

FIG. 6 illustrates an exemplary computer system in which various embodiments of the present invention can be implemented.

### DETAILED DESCRIPTION OF THE INVENTION

A system and a method for providing a framework having a query building logic for supporting testing requirements based on prerequisite business conditions of the testers are described. The invention provides for a system and method that facilitate the testers to extract test data by generating effective queries. Further, the invention provides for a system and method for analyzing one or more complex business conditions based on which data can be extracted for testing purposes. In addition, the invention provides for a system and method for dynamically generating one or more queries corresponding to the prerequisite business conditions without having the need to know query programming language and to be familiar with the underlying database schemas by the testers.

The following disclosure is provided in order to enable a person having ordinary skill in the art to practice the invention. Exemplary embodiments are provided only for illustrative purposes and various modifications will be readily apparent to persons skilled in the art. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

The present invention would now be discussed in context of embodiments as illustrated in the accompanying drawings.

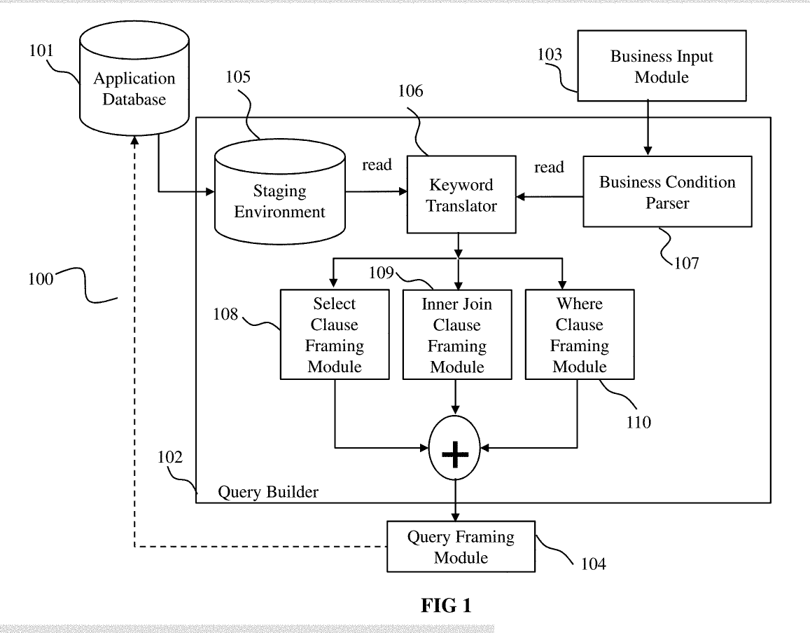

FIG. 1 is a block diagram illustrating a system for providing a test data specification (TDS) framework, in accordance with an embodiment of the present invention. The system 100 comprises an application database 101, a TDS framework 102, a business input module 103, and a query framing module 104.

The application database 101 comprises one or more databases and database servers for storing and managing information and data in a structured manner. In other words, the application database 101 stores metadata of one or more database schemas or database models that defines structures of one or more tables of the database, one or more fields in each of the tables, the relationships between the fields and tables, etcetera. For example, the application database 101 may include Oracle servers and SQL (structured Query Language) servers that are used to store and manage huge data and metadata in form of database schemas and database models that can also be updated by adding, modifying, and deleting the data. The database schemas may include metadata pertaining to various business models, business components and products, and business conditions of various business domains; for example retail business, insurance business, banking etcetera.

The TDS framework 102 is a testing framework having in-built query building logic for supporting testing requirements based on prerequisite business conditions and business requirements of the QA/testers, hereinafter users. The TDS framework 102 comprises a staging environment module 105, a keyword translator 106, a business condition parser 107, a select clause framing module 108, an inner join clause framing module 109, and a where clause framing module 110. The select-clause framing module 108, the inner-join-clause framing module 109, and the where-clause framing module 110 together forms the in-built query building logic of the TDS framework 102.

The TDS framework 102 receives business inputs from the users and generates complex queries dynamically. The TDS framework 102 establishes a connection with the application database 101 to access the data and metadata of the application database 101. The TDS framework 102 connects to the application database 101 via one or more communication channels or mediums to access one or more database schemas and/or models stored in the application database 101. As explained above the metadata comprises information/details of one or more database schema having one or more tables and their corresponding rows, columns, referential integrity, views, constraints etcetera. In one embodiment of the present invention, the user is prompted for inputting authentication details to access the data of the application database 102 via a user interface of a user device. The users may be required to register with the application database 102 to access the data. Only the authorized or authenticated users may be allowed to send queries and extract data. The queries sent by the users are generated by the TDS framework's in-built query generation logic. The TDS framework further executes the generated complex queries to extract required data for the users. The extracted data are displayed to the users in the form of grid. This facilitate the users to search for the data from the databases in order to accomplish the task of testing based on the desired business conditions.

The business input module 103 receives business inputs from one or more users (QA/testers) and sends it to the TDS framework 102 for generating complex queries based on the requirement of the users. The user interface may be provided to the user via one or more user devices such as computer, laptop, mobile devices, smart phones, tablets etcetera to facilitate the user to set prerequisite business requirements, based on which the user may generate appropriate queries in order to extract data with precision from the application database 101. For example, if a user wants to extract data of customers buying shoes using credit cards, then he/she may set the prerequisite business conditions pertaining to sale of shoes in retail business domain.

The business input module 103 sends the business inputs to the business condition parser 107. The business condition parser 107 receives the business inputs and performs analysis of the inputs for parsing. The business condition parser 107 break down the inputted words and texts into one or more components and keywords. The business condition parser 107 further performs analysis of one or more forms, functions, and syntactic relationships of each component and keyword for identifying one or more entities, one or more parameters, and one or more business conditions. The business condition parser 107 further identifies one or more filter criteria to filter the data. The filter criteria are the identified business conditions for which the user wishes to search the data. Once the entities, parameters and the business conditions are identified based on the business inputs, the keyword translator 106 communicates with business condition parser 107 to identify the required entities and set of parameters on which business condition is given. Once these entities and parameters are identified, the keyword translator 106 identifies the set of related predefined parameters from the staging environment module 105 for receiving one or more sets of predefined parameters. The predefined parameters are sent by the application database 102. The predefined parameters as received from the application database 102 include but not limiting to the business environments respective to one or more business domains, structures of data, models, schemas, which may be needed as inputs by the query building logic to build the queries. These identified entities, identified parameters, identified business conditions along with the predefined parameters together form a source of input to the inbuilt query building logic of the TDS framework 102 for dynamically generating one or more queries.

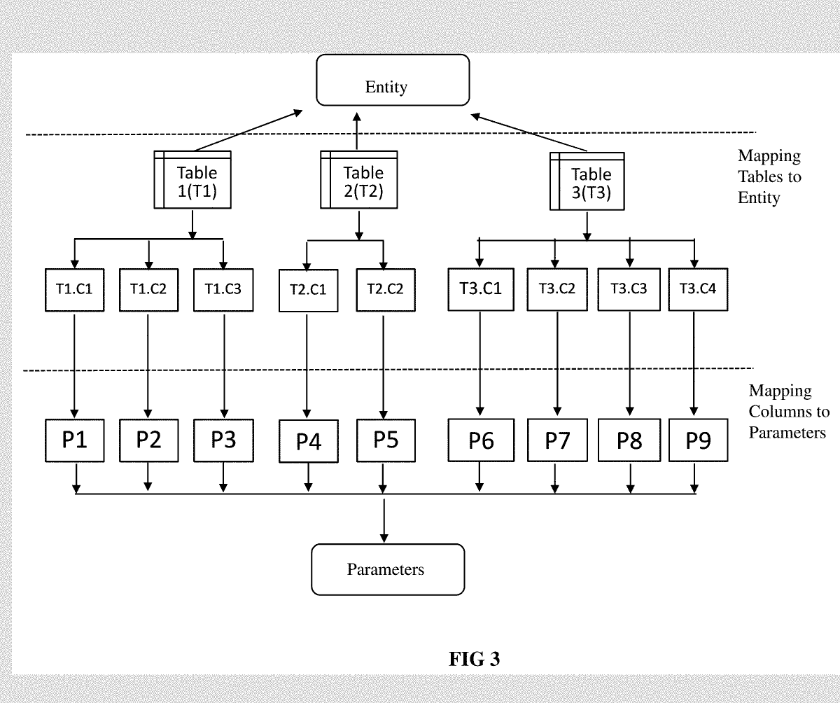

The staging environment 105 acts as an intermediate environment where all the metadata of the application database 101 are maintained. In addition to the metadata of the application database 101, the staging environment 105 also contains one or more identified entities along with their mapped tables. In addition, it also contains and maintains mapping details of entities and parameters of the database schemas. The mapping of the identified entities and parameters are explained later in the description of FIG. 3. The staging environment 105 facilitates the movement of web-based data within and across different environments. For example, metadata and database schema may be moved to a test environment via the staging environment 105. In an embodiment of the present invention, the staging environment 105 comprises various components including but not limited to staging database server, staging server etcetera that facilitates in storing and managing database contents. The staging environment 105 facilitates the users to update various aspects of business tasks of the users in various remote locations. For example, a user may update data pertaining to a retail website at headquarters in one location, while another user may deploy the updated environment for performing the test operations locally in another location. The staging environment thus helps in maintaining and updating the data in remote locations.

The keyword translator 106 analyzes the data received from the business condition parser 107 and the staging environment 105 to perform the translation of the received data in standard keywords. The keyword translator engine 106 thus analyzes the identified entities and identified parameters as sent by the business condition parser 107 and selects one or more entities and parameters to generate one or more logic tables for the selected entity, parameters and their relationship with the help of metadata imported from the staging environment 105. These three attributes in the inputs are combine together to build/frame a dynamic and complex query.

The TDS framework 102 further comprises the select-clause framing module 108, the inner-join-clause framing module 109, and the where-clause framing module 110 which are the in-built query building logic of the TDS framework 102. The TDS framework 102 builds the complex query dynamically by using the three modules the select-clause framing module 108, the inner-join-clause framing module 109, and the where-clause framing module 110. The users may submit the business inputs or the query statements indicating data to be retrieved for testing. The query statements may include the business conditions and requirements sought by the users. The query logic of the TDS framework divides and classifies the query statement information into three tiers including entity, parameters and conditions. Each tier can be combined together to form a complete query. Each of the modules are discussed below in detail.

The select-clause framing module 108 extracts one or more identified parameters from the keyword translator 106. These parameters are used to separately frame the select clause without creating any impact on the other business logics. These parameters are displayed to the users on the user device to allow the user to select one or more parameters as per user preferences. For example, in a retail business scenario, a user may wish to have data on an item purchased by customers through online order. In this scenario, the entity may be identified as ‘orders’, and the parameter may be identified as ‘order id’. Thereafter all possible logics may be defined for the identified entity and the identified parameter (i.e. ‘order’ and ‘order id’). The select-clause framing facilitate the user to select the parameters which may later be used with one of the possible logics to define a relationship between the entity and the parameters.

The inner-join-clause framing module 109 extracts one or more entities from the keyword translator 106. The extracted entities are analyzed based on the physical constraints (Database layer) and the logical constraints (Application layer) that are imposed on the data model or database schema to frame inner-join clauses and to validate if the given criteria satisfies the complete data model. The inner-join-clause framing module 109 uses a join clause, for joining one or more related tables based on the level of hierarchy. The hierarchy level is explained below with the help of sub-modules of the inner-join-clause framing module 109.

In one embodiment of the present invention, the inner-join-clause framing module 109 further comprises one or more sub-modules including but not limited to find-parent module, find children module, referential (RI) table module, grandparent module and sub-inner module.

The Find Parents module helps in locating all the parent tables for the given entity (tables) which may facilitate in framing dynamic inner join query.

The Find Children module performs the task of searching for all the child tables in the database for any given entity that may be used for framing the dynamic query.

The RI Tables (Referential Integrity) module analyzes both the physical and logical constraints and frames the dynamic query by complying the conditions in the complete data model.

The Grand Parents module receives the list of all grandparents of the complete model to frame the dynamic inner join query.

The Inner join module—This framework frame the inner join part of the query by starting from any one grand parent and proceeding to its child until it reaches the grandchild.

The where-clause-framing module 110 performs the function of filtering out the criteria or business requirement which the users are looking for. The where clause framing module 110 separately frames a ‘where clause’ based on the given business input and conditions set by the user to extract the filter criteria. Finally the complete query is built by receiving the output from the above mentioned modules and thereby providing the results in the form of data grid.

The dynamic query framing module 104 receives the three tier data from all the modules and sub-modules of the TDS framework 102. In other words, the data related to tables, columns and referential integrity are gathered to generate or frame complex queries based on the business conditions dynamically. The three tier data facilitates in dynamic generation of the complex queries without having the need of knowing complex query languages by the users to generate the queries. All the complex logics are hidden from the user and the users are able to easily frame the complex queries to extract the data required for testing.

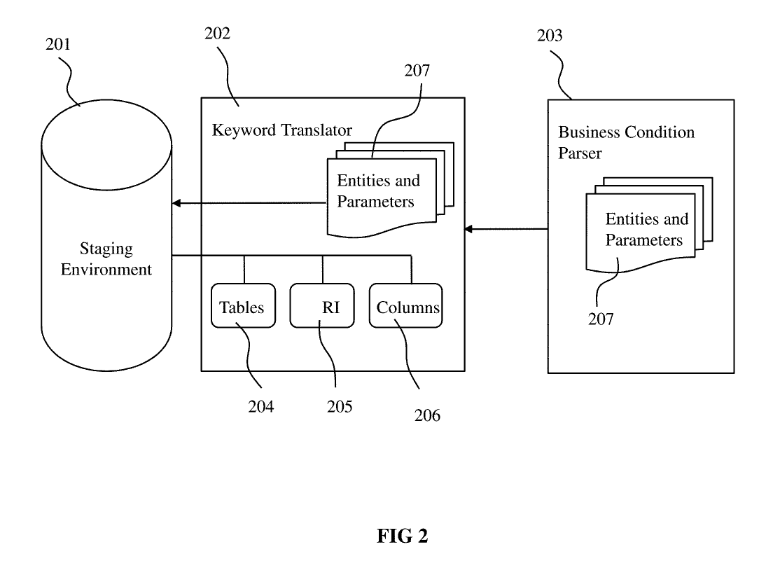

FIG. 2 illustrates parsing of the user inputs and keywords for identifying the business conditions, in accordance with an embodiment of the present invention. The business condition parser 203 parses the business inputs received from the users and classifies the data into three tiers including one or more entities, one or more parameters, and one or more conditions. The one or more entities and parameters are used by the keyword translator 202 for performing the analysis of the one or more entities and parameters based on the business conditions. The one or more analyzed entities and parameters are thereafter selected to generate one or more tables 204, Referential Integrity (RI) 205, and columns 206 for the selected entity and parameters. The staging environment 105 facilitates in providing logical structures of the tables 204, RI 205, and the columns 206, from the application database to the keyword translator 202. Thereafter, the keyword translator 202 maps the logical structures imported from the staging environment 201 to generate the tables 204, RI 205, and the columns 206. The Referential integrity (RI) 205 defines the concept of relational database wherein multiple tables share a consistent relationship based on the data stored in the tables. To maintain a consistent relationship, every value of one column of a table must exist as a value of another column in a different or the same table. The complex query generated by the TDS framework complies with the model of referential integrity (RI) 205.

FIG. 3 is the representation of entity and parameter mapping, in accordance with an embodiment of the present invention. The one or more tables are mapped to one or more entities as shown. For example, tables T1, T2 and T3 are mapped to the one or more entities and store in one or more corresponding columns as T1.C1, T1.C2, T1.C3, T2.C1, T2.C2, T3.C1, T3.C2, and so on. Further, the columns are mapped to one or more parameters for example P1, P2, P3, P4 etcetera. Thus, the entities and the parameters are mapped to tables and columns in the three tier mapping fashion wherein any business requirements of a user can be mapped to one or more ‘entities’ which in turn can have one or more associated ‘parameters’ and each parameter in turn may have one or more ‘business conditions’. Each of these three layers is mapped to the tables and columns to facilitate the users to generate dynamic queries. The users do not need to have detailed knowledge of the complex mapping. The users facilitated to choose any combination of the three tier mapping. The combination of the entities, the parameters and the conditions dynamically build the query corresponding to the required business conditions without requiring the end user to know complex query languages such as SQL.

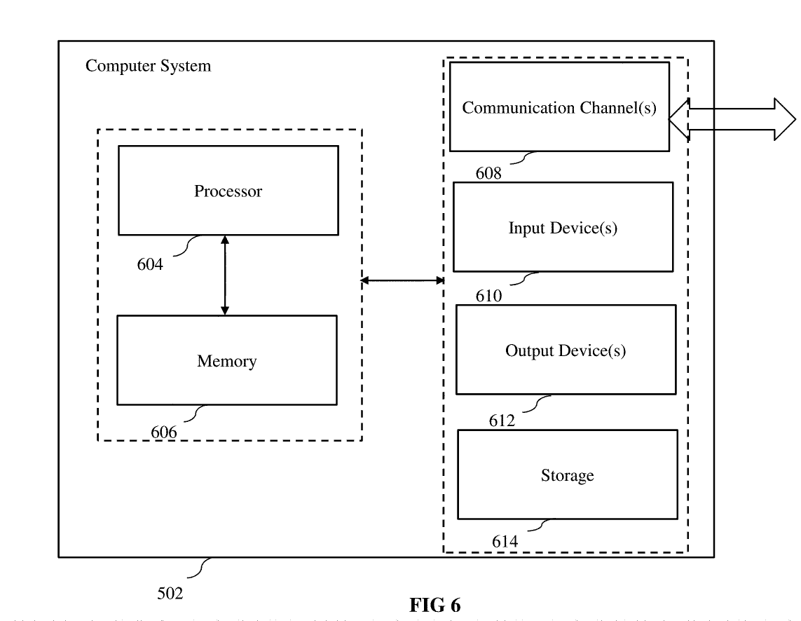

FIG. 4 illustrates representations of three-tier mapping of one or more entities, parameters, and business conditions for a business domain, in accordance with an exemplary embodiment of the present invention. As shown in the figure, the components of the queries comprises three units namely entities, parameters and conditions. For example, for an entity ‘order’, one or more parameters can be selected such as ‘product type’, or ‘order placed’ or any other parameter etcetera. The condition for this scenario may be set as ‘shoes’. Therefore, the user may retrieve data pertaining to ‘orders’ of item ‘shoes’ purchased through an ‘order placed’. Thus, business conditions, entities and parameters can be mapped to the logical structures of tables, RI, and columns as received from the application database via the staging environment. The mapping of the business conditions, entities and parameters to the logical structures imported from the staging environment is thus performed by the TDS framework. The TDS framework thus facilitates the users to dynamically select any combination of entities/parameters/conditions. Upon selection of inputs from the users, a query is dynamically generated that matches the combinations. The end user is shielded from all the complexities of mapping the user inputs to the required tables, RI and columns.

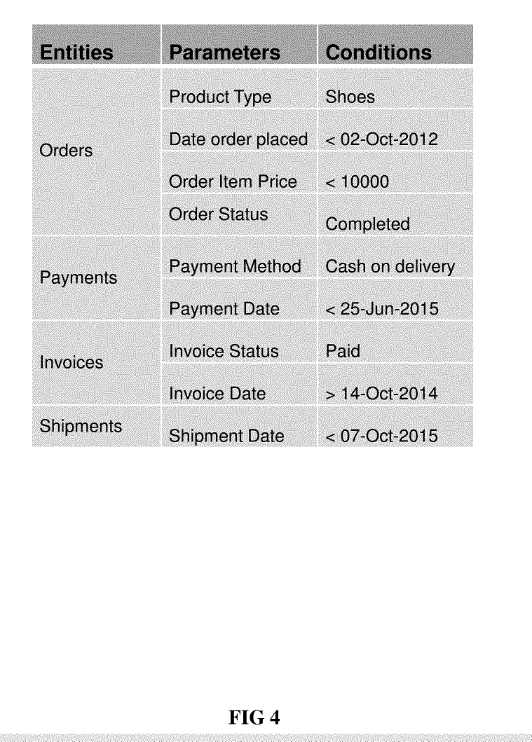

FIG. 5 is a flowchart illustrating the process of configuring the TDS framework, in accordance with an exemplary embodiment of the present invention. At step 502, business inputs from one or more users are received. The business inputs are received via a business input module from one or more users (QA/testers). The business inputs are sent to the TDS framework for generating complex queries based on the requirement of the users. A user interface may be provided to the user via one or more user devices such as computer, laptop, mobile devices, smart phones, tablets etcetera to facilitate the user to set prerequisite business requirements, based on which the user may generate appropriate queries in order to extract data with precision from the application database 101.

At step 502 the received business inputs are parsed to identify one or more entities, parameters and business conditions based on which the users wish to frame queries. The business input module sends the business inputs to the business condition parser for parsing. The business condition parser breaks down the inputted words and texts into one or more components and keywords. The business condition parser also performs analysis of one or more forms, functions, and syntactic relationships of each component and keyword for identifying one or more entities, one or more parameters, and one or more business conditions.

At step 506, separate clauses are formed namely the select clause, inner-join clause and where clause based on the identified parameters, entities and business conditions respectively. The TDS framework comprises the select-clause framing module, the inner-join-clause framing module, and the where-clause framing module which are the in-built query generation logic of the TDS framework. The users may submit the business inputs for seeking data to be retrieved for testing. The business inputs may be in the form of query statements. The query logic of the TDS framework divides and classifies the query statement information into three tiers including entity, parameters and conditions. Each tier can be combined together to form a complete query.

At step 508 the separately framed select clause, inner-join clause and where clause are combined to form the complete query. The dynamic query framing module receives the three tier data from all the modules and sub-modules of the TDS framework. In other words, the data related to tables, columns and referential integrity are gathered to generate or frame complex queries based on the business conditions dynamically. The query is then displayed to the users on the user device. Thus, the generation of the query is dynamic based on the dynamic requirements of the users.

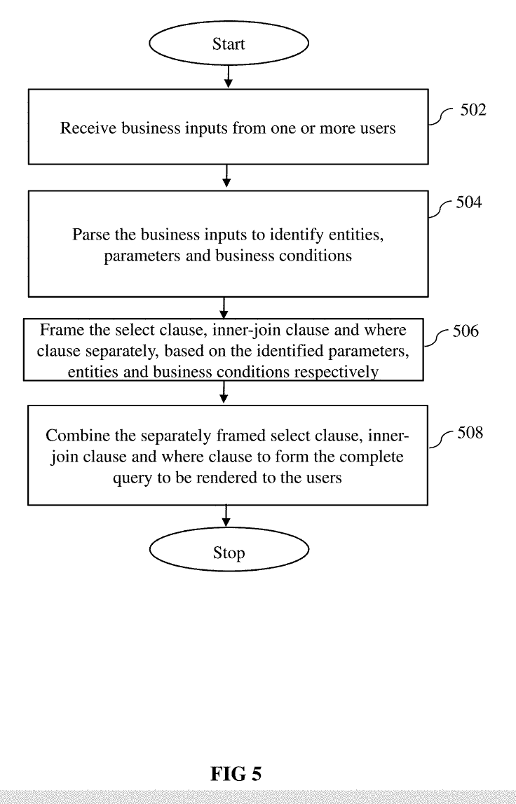

FIG. 6 illustrates an exemplary computer system in which various embodiments of the present invention may be implemented. The computer system 602 comprises a processor 604 and a memory 606. The processor 604 executes program instructions and may be a real processor and/or a virtual processor. The computer system 602 is not intended to suggest any limitation as to scope of use or functionality of described embodiments. For example, the computer system 602 may include, but is not limited to, a general-purpose computer, a programmed microprocessor, a micro-controller, a peripheral integrated circuit element, and other devices or arrangements of devices that are capable of implementing the steps that constitute the method of the present invention. In an embodiment of the present invention, the memory 606 may store software for implementing various embodiments of the present invention. The computer system 602 may have additional components including one or more communication channels 608, one or more input devices 610, one or more output devices 612, and storage 614. An interconnection mechanism (not shown) such as a bus, controller, or network, interconnects the components of the computer system 602. In various embodiments of the present invention, operating system software provides an operating environment for various processes being executed in the computer system 602, and manages different functionalities of the components of the computer system 602.

The communication channel(s) 608 allow communication over a communication medium to various other computing entities. The communication medium provides information such as program instructions, or other data in a communication media. The communication media includes, but is not limited to, wired or wireless methodologies implemented with an electrical, optical, RF, infrared, acoustic, microwave, Bluetooth or other transmission media.

The input device(s) 610 may include, but not limited to, a keyboard, mouse, pen, joystick, trackball, a voice device, a scanning device, or any another device that is capable of providing input to the computer system 602. In an embodiment of the present invention, the input device(s) 610 may be a sound card or similar device that accepts audio input in analog or digital form. The output device(s) 612 may include, but not limited to, a user interface on CRT or LCD, printer, speaker, CD/DVD writer, or any other device that provides output from the computer system 602.

The storage 614 may include, but is not limited to, magnetic disks, magnetic tapes, CD-ROMs, CD-RWs, DVDs, flash drives or any other medium which can be used to store information and can be accessed by the computer system 602. In various embodiments of the present invention, the storage 614 contains program instructions for implementing the described embodiments.

The present invention may suitably be embodied as a computer program product for use with the computer system 602. The method described herein is typically implemented as a computer program product, comprising a set of program instructions which is executed by the computer system 602 or any other similar device. The set of program instructions may be a series of computer readable codes stored on a tangible medium, such as a computer readable storage medium (storage 614), for example, diskette, CD-ROM, ROM, flash drives or hard disk, or transmittable to the computer system 602, via a modem or other interface device, over either a tangible medium, including but is not limited to optical or analogue communications channel(s) 608. The implementation of the invention as a computer program product may be in an intangible form using wireless techniques, including but not limited to microwave, infrared, Bluetooth or other transmission techniques. These instructions can be preloaded into a system or recorded on a storage medium such as a CD-ROM, or made available for downloading over a network such as the internet or a mobile telephone network. The series of computer readable instructions may embody all or part of the functionality previously described herein.

The present invention may be implemented in numerous ways including as an apparatus, method, or a computer program product such as a computer readable storage medium or a computer network wherein programming instructions are communicated from a remote location.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims.

What is claimed is:

1. A system for providing a query building logic for supporting testing requirements, the system comprising:
one or more computer processors executing program instructions stored in one or more storage devices, at least one computer processor of the one or more computer processors configuring:
a business input module for receiving one or more business inputs from one or more users;
an application database for rendering one or more unique database schemas and a set of predefined parameters, the application database being accessed by at least one user to select one or more database schemas and identify one or more predefined parameters based on one or more business conditions set for the at least one user;
a TDS (Test Data Specification) framework comprising a dynamic query framing module for dynamically generating one or more queries based on the one or more business inputs, the selected one or more database schemas, and the identified one or more parameters;
wherein the TDS framework establishes a connection with the application database using one or more communication channels to extract the selected one or more database schemas, further wherein the TDS framework communicates with the business input module to receive the one or more business inputs.

2. The system as in claim 1, further comprising:
a staging environment module for maintaining metadata of the application database, and maintaining mapping information pertaining to the one or more database schemas of the application database; and
a business condition parser for parsing the business inputs received from the users and classifying the parsed data into one or more entities, one or more parameters, and the one or more business conditions.

3. The system as in claim 2, further comprising a keyword translator for:
analyzing the one or more entities and one or more parameters based on the one or more business conditions;
selecting the one or more analyzed entities and parameters based on user preferences; and
mapping the one or more selected entities and parameters based on the mapping information.

4. The system as in claim 3, wherein the one or more entities are mapped to one or more tables by using the mapping information.

5. The system as in claim 3, wherein the one or more parameters are mapped to one or more columns by using the mapping information.

6. The system as in claim 1, wherein the one or more business conditions are mapped to Referential Integrity (RI) by using the mapping information.

7. The system as in claim 1, wherein the TDS framework comprises a query building logic having a select clause framing module, an inner join clause framing module and a where clause framing module, wherein each module separately frames one or more clauses of the query generated.

8. The system as in claim 7, wherein the query is generated by the dynamic query framing module by combining the separately formed one or more clauses.

9. A method for providing a query building logic for supporting testing requirements, the method comprising the steps of:
configuring one or more computer processors by executing program instructions stored in one or more storage devices, at least one computer processor of the one or more computer processors being configured for:
receiving one or more business inputs from one or more users via one or more user communication devices;
rendering one or more unique database schemas and a set of predefined parameters by an application database, wherein the application database is being accessed by at least one user to select one or more database schemas and identify one or more predefined parameters based on one or more business conditions set for the at least one user;
configuring a TDS (Test Data Specification) framework comprising a dynamic query framing module for dynamically generating one or more queries based on the one or more business inputs and the selected one or more database schemas;
wherein the TDS framework establishes a connection with the application database using one or more communication channels to extract the selected one or more database schemas, further wherein the TDS framework communicates with the business input module to receive the one or more business inputs.

10. The method as in claim 9, further comprising the steps of:
maintaining metadata of the application database in a staging environment module;
maintaining mapping information pertaining to the one or more database schemas of the application database;
parsing the business inputs received from the users by using a business condition parser; and
classifying the parsed data into one or more entities, one or more parameters, and the one or more business conditions.

11. The method as in claim 10, further comprising the steps of:
analyzing the one or more entities and one or more parameters based on the one or more business conditions;
selecting the one or more analyzed entities and parameters based on user preferences; and
mapping the one or more selected entities and parameters based on the mapping information.

12. The method as in claim 11, wherein the one or more entities are mapped to one or more tables by using the mapping information.

13. The method as in claim 11, wherein the one or more parameters are mapped to one or more columns by using the mapping information.

14. The method as in claim 11, wherein the one or more business conditions are mapped to Referential Integrity (RI) by using the mapping information.

15. The method as in claim 9, further comprising the step of configuring a select clause framing module, an inner join clause framing module and a where clause framing module within the query building logic, wherein each module separately frames one or more clauses of the query generated.

16. The method as in claim 15, wherein the query is generated by the dynamic query framing module by combining the separately formed one or more clauses.
